(19) United States
(12) Patent Application Publication
(10) Pub. No.: US 2016/0247194 A1
(43) Pub. Date: Aug. 25, 2016

(54) EXTRACTION DEVICE, EXTRACTION METHOD, AND NON-TRANSITORY COMPUTER READABLE STORAGE MEDIUM

(71) Applicant: YAHOO JAPAN CORPORATION, Tokyo (JP)

(72) Inventors: Yohei MORISHITA, Tokyo (JP); Tatsuya UCHIYAMA, Tokyo (JP); Naoki ISHIKAWA, Tokyo (JP); Yasuyuki TANAKA, Tokyo (JP)

(73) Assignee: YAHOO JAPAN CORPORATION, Tokyo (JP)

(21) Appl. No.: 14/991,332

(22) Filed: Jan. 8, 2016

(30) Foreign Application Priority Data
Feb. 20, 2015 (JP) 2015-032103

(51) Int. Cl. G06Q 30/02; H04L 29/08

(52) U.S. Cl. CPC G06Q 30/0255; H04L 67/10

(57) ABSTRACT

An extraction device includes an acquiring unit, an operation control unit, and an extracting unit. The acquiring unit acquires a distribution request for advertising content including transmission source information. The operation control unit performs a determination process of determining whether an advertising content corresponds to a distribution condition that is set in advance for each advertising content and a calculation process of calculating a score indicating a degree of match between the transmission source information and feature information of the advertising content, with respect to each single advertising content in a group of advertising contents as distribution candidates, on the basis of the transmission source information acquired by the acquiring unit. The extracting unit extracts an advertising content corresponding to the distribution request from the group of the advertising contents on the basis of results of the processes performed by the operation control unit.

### CROSS-REFERENCE TO RELATED APPLICATION(S)

The present application claims priority to and incorporates by reference the entire contents of Japanese Patent Application No. 2015-032103 filed in Japan on Feb. 20, 2015.

### BACKGROUND OF THE INVENTION

1. Field of the Invention

The present invention relates to an extraction device, an extraction method, and a non-transitory computer readable storage medium having stored therein an extraction program.

2. Description of the Related Art

In recent years, with the rapid spread of the Internet, advertisement distribution based on information acquired through a network has been frequently performed. In the advertisement distribution, to improve an advertising effect, targeted advertisement distribution is performed, in which user information, such as preference, gender, age, address, and occupation of the user, is registered in advance and an advertisement corresponding to the user information is selectively distributed. Furthermore, contextual advertisement distribution is performed, in which content, such as a web page, for displaying an advertisement is analyzed and an advertisement corresponding to a feature (theme or the like) of the content is extracted. Moreover, advertisement distribution is performed, in which an advertiser assigns a Boolean (logical value) condition to an advertising content itself to specify a user to whom the advertisement is to be provided.

There is a known technique for dynamically adjusting the ratio of contextual advertising and targeted advertising to be employed, in order to extract an advertising content expected to achieve a high advertising effect.

However, in the conventional technique, it is difficult to promptly extract an advertising content with a high appeal effect. Specifically, in the conventional technique, it is possible to adjust a ratio of different extraction methods such as the contextual advertising and the targeted advertising, but it is difficult to combine the different extraction methods. That is, conventionally, a method for extracting an advertising content is limited to any of the methods, and it is difficult to combine the methods by taking advantage of the superiority of each of the methods in order to extract an advertising content with a high advertising effect. Furthermore, even if the methods are combined, it takes a longer processing time than the advertisement extraction using one of the methods. Therefore, it is difficult to use the conventional method in the field of network advertising in which it is needed to find advertising content in a short time.

### SUMMARY OF THE INVENTION

It is an object of the present invention to at least partially solve the problems in the conventional technology.

An extraction device according to the present application includes an acquiring unit that acquires a distribution request for advertising content including transmission source information as information on a transmission source of the distribution request, and an operation control unit that performs a determination process of determining whether an advertising content corresponds to a distribution condition that is set in advance for each advertising content and a calculation process of calculating a score indicating a degree of match between the transmission source information and feature information on the advertising content, with respect to each single advertising content in a group of advertising contents as distribution candidates on the basis of the transmission source information acquired by the acquiring unit, and an extracting unit that extracts an advertising content corresponding to the distribution request from the group of the advertising contents on the basis of results of the processes performed by the operation control unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of an extraction process according to an embodiment;

FIG. 2 is a diagram illustrating a configuration example of an extraction processing system according to the embodiment;

FIG. 3 is a diagram illustrating a configuration example of an advertising device according to the embodiment;

FIG. 4 is a diagram illustrating an example of an advertisement information storage unit according to the embodiment;

FIG. 5 is a diagram illustrating an example of a user information storage unit according to the embodiment;

FIG. 6 is a diagram illustrating an example of an operation table according to the embodiment;

FIG. 7 is a flowchart illustrating the flow of the extraction process performed by the advertising device according to the embodiment; and

FIG. 8 is a diagram illustrating an example of a hardware configuration of a computer that implements functions of the advertising device.

### DETAILED DESCRIPTION OF THE PREFERRED EMBODIMENTS

Modes (hereinafter, referred to as “embodiments”) for carrying out an extraction device, an extraction method, and an extraction program according to the present application will be described in detail below with reference to the drawings. The extraction device, the extraction method, and the extraction program of the present application are not limited by the embodiments. The embodiments may be combined appropriately as long as the processes do not conflict with each other. In each of the embodiments below, the same components will be denoted by the same reference numerals and symbols, and description thereof will be omitted.

1. Example of Extraction Process

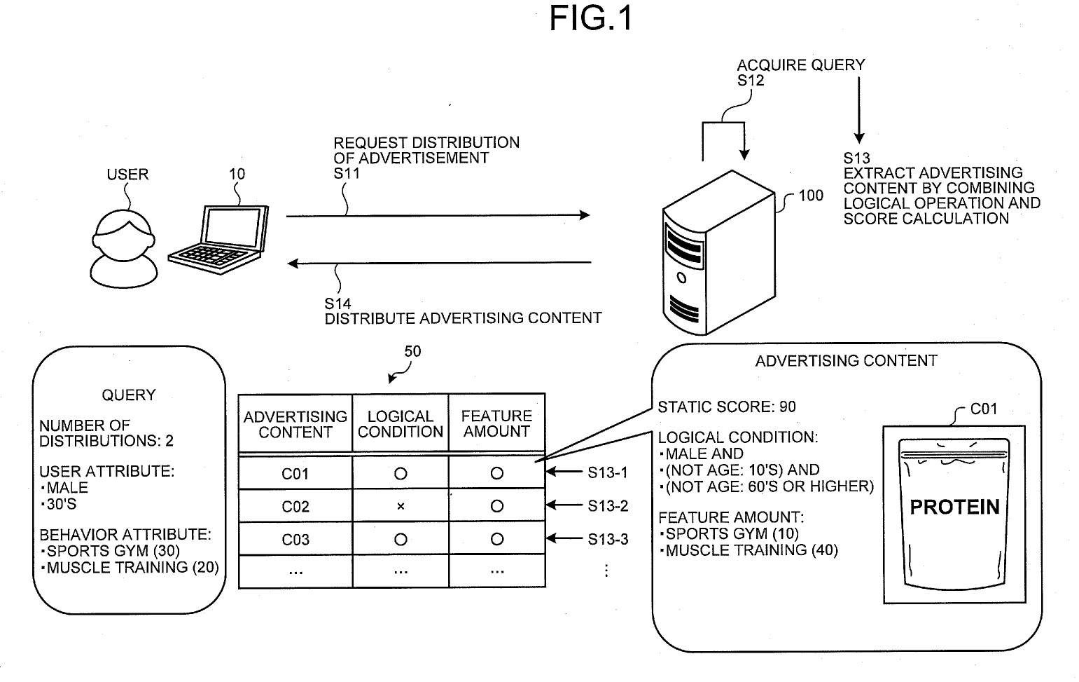

First, an example of an extraction process according to an embodiment will be described with reference to FIG. 1. FIG. 1 is a diagram illustrating an example of the extraction process according to the embodiment. FIG. 1 illustrates an example in which an advertising device 100 corresponding to the extraction device according to the embodiment performs a process of extracting an advertising content to be distributed to a user terminal 10.

The advertising device 100 is a server device that extracts an advertising content appropriately matched with the user terminal 10 serving as a distribution target destination, on the basis of a query transmitted from the user terminal 10. Specifically, the advertising device 100, by using a predetermined method, searches for advertising contents expected to achieve high advertising effects on a specific user from among advertising contents submitted from an advertiser. Then, the advertising device 100 extracts an advertising content to be actually distributed to the user from among the retrieved advertising contents, and distributes the extracted advertising content to the user terminal 10. That is, by using the advertising device 100, the advertiser can implement distribution of an advertising content that can obtain a certain result from a user upon distribution of the advertisement or an advertising content that can probably improve a click rate, in other words, an advertising content with a high advertising effect.

The query includes an attribute (for example, gender, age-group, or the like) of a user who operates the user terminal 10, and a behavior attribute (for example, information on a hobby in which the user is interested in, a category of a frequently-viewed web page, or the like) of the user. The query is transmitted from the user terminal 10 to the advertising device 100 when distribution of an advertising content is requested. The advertising device 100 extracts an advertising content suitable for the user on the basis of the transmitted query.

The advertising device 100 searches for advertising content from among distribution candidate advertising contents by using two different methods, and extracts an advertising content appropriate for distribution. As a first method, the advertising device 100 performs a search by using logical operation. Specifically, the advertising content handled by the advertising device 100 includes designation made by an advertiser with regard to a user to be a distribution target. The designation is set as a logical condition for each advertising content. Here, the logical condition is a conditional expression used in calculus of logic (logical operation or Boolean operation), such as AND, OR, or NOT. More specifically, if the advertiser desires to distribute an advertising content to “teenage males”, the advertiser sets a conditional expression “(age: 10's) AND (gender: male)” in the advertising content. The advertising device 100 performs logical operation using a known algorithm, such as the conjunctive normal form (CNF) algorithm, the disjunctive normal form (DNF) algorithm, or the interval algorithm, and determines whether an advertising content satisfies the conditional expression. Therefore, the advertiser can distribute an advertising content to the user who satisfies a desired condition. Details of the algorithms related to the above-described logical operation are disclosed in, for example, Document 1 and Document 2 listed below.

(Document 1) Steven Euijong Whang, Hector GarciaMolina, Chad Brower, Jayavel Shanmugasundaram, Sergei Vassilvitskii, Erik Vee, “Indexing Boolean Expressions” [online], [searched on Feb. 13, 2015], Internet (http://theory.stanford.edu/˜sergei/papers/vldb09-indexing.pdf)

(Document 2) Marcus Fontoura, Suhas Sadanandan, Jayavel Shanmugasundaram, Sergei Vassilvitski, Erik Vee, Srihari Venkatesan, Jason Zien, “Efficiently Evaluating Complex Boolean Expressions” [online], [searched on Feb. 18, 2015], Internet (http://theory.stanford.edu/˜sergei/papers/sigmod10-index.pdf)

As a second method, the advertising device 100 calculates a score for each advertising content, and searches for an advertising content appropriate for distribution on the basis of the magnitude of the calculated score. In this case, the advertising device 100 searches for the advertising content by a method using the WAND algorithm. In the WAND algorithm, each advertising content is provided with a score with respect to the query, and a maximum score value for each query is recorded in an index. Then, search results corresponding to the target number of searches of the advertising contents are obtained based on the query score set for each query and the maximum score value recorded in the index. Specifically, in the score calculation method, with use of the WAND algorithm, the number of advertising contents to be searched for, that is, the target number of searches, is assumed as k (k is an arbitrary number), and top-k advertising contents with higher scores among the distribution candidate advertising contents are retrieved.

As a specific score calculation method to search for advertising contents, the advertising device 100 uses feature information included in advertising contents. For example, the advertising device 100 calculates, as a score, the degree of match between the query and a feature amount (for example, a combination of a keyword and a value is used as an element of the feature amount) that is the feature information set for each advertising content. Specifically, the advertising device 100 calculates, for each query, a product of the feature amount of an advertising content and a query score set for the query, calculates a sum of the calculated products, and employs the sum as a total score of the advertising content. In this case, in the WAND algorithm, because the maximum score of each advertising content with respect to the query is recorded in the index, if the total score of a single advertising content is calculated, it is possible to determine whether calculations of total scores of other advertising contents can be skipped by using the calculated total score as a threshold. Therefore, it is possible to promptly search for an advertising content. Details of the above-described WAND algorithm are disclosed in, for example, Document 3 listed below.

(Document 3) Deepak Agarwal, Maxim Gurevich, “Fast top-k retrieval for model based recommendation”, “WSDM '12 Proceedings of the fifth ACM international conference on Web search and data mining”, the United States of America, “ACM New York”, Feb. 8, 2012, pages 483 to 492.

The advertising device 100 uses both of the method of searching for an advertising content according to whether a condition set by the advertiser is satisfied on the basis of a query transmitted from the user terminal 10 (method using logical operation) and the method of searching for an advertising content by expressing matching between the interest of the user and the content of the advertising content by a score (method using a score calculation). By using both of the two different methods as described above, the advertising device 100 promptly extract an advertising content with a high appeal effect. An example of the flow of the process of extracting an advertising content by the advertising device 100 will be described below.

As illustrated in FIG. 1, the user terminal 10 requests the advertising device 100 to distribute an advertising content (Step S11). The request for the distribution is generated when, for example, the user terminal 10 acquires a web page including an advertising space and the user terminal 10 transmits a distribution request for an advertising content for the advertising space.

When accessing a web server that provides a web page, the user terminal 10 transmits and receives hypertext transfer protocol cookie (HTTP cookie: hereinafter, simply described as a “cookie”) that is information transmitted and received between a web browser and the web server. Therefore, information on the user, such as the content of a service used by the user terminal 10 over the Internet or information on a web page that has been viewed, is stored.

The advertising device 100 acquires, on the basis of the information on the user stored in the cookie for example, the information as a query (Step S12). In the example in FIG. 1, the advertising device 100 acquires a query indicating a request for distribution of “two” advertising contents from the user of the user terminal 10 that requests distribution of an advertising content. Furthermore, the advertising device 100 acquires, as the query, information indicating that the user attributes of the user who transmits the query are “male” and “30's”. Moreover, the advertising device 100 acquires, as the query, information such as “sports gym” and “muscle training” as behaviors (behavior attributes) in which the user is interested. Then, the advertising device 100 acquires words indicating the behavior attributes of the user and query scores set for the respective words such as “sports gym” and “muscle training” on the basis of behaviors of the user (for example, frequency of viewing a web page, purchase history in web shopping, or the like). In the example in FIG. 1, it is assumed that a query score of “30” is given to “sports gym” and a query score of “20” is given to “muscle training” for the user who operates the user terminal 10.

Then, the advertising device 100 extracts an advertising content to be distributed to the user terminal 10 by combining the search method using logical operation and the search method using the score calculation, on the basis of the acquired query (Step S13). First, the advertising device 100 sorts (aligns), in descending order, static scores that are set in advance for the respective advertising contents. Subsequently, the advertising device 100 sequentially searches for an advertising content appropriate for distribution through the two methods using the logical operation and the score calculation on the sorted distribution candidate advertising contents. In FIG. 1, an example is illustrated in which the advertising device 100 searches for an advertising content by using a data table 50 that indicates a submitted advertising content and a processing result on the advertising content. As illustrated in FIG. 1, the advertising device 100 first processes an advertising content C01 (Step S13-1), subsequently processes an advertising content C02 (Step S13-2), and then processes an advertising content C03 (Step S13-3). In the following, a process of searching for the advertising content C01 will be described.

First, the advertising device 100 performs logical operation as to whether the user of the user terminal 10 satisfies a conditional expression that is set for each advertising content by the advertiser, and derives a result. In the example in FIG. 1, the advertising device 100 calculates whether the user satisfies a conditional expression “(male) AND (NOT: age: 10's) AND (NOT: age: 60's or higher)” set for the advertising content C01. In the example in FIG. 1, the user satisfies the conditional expression of the advertising content C01. Therefore, the advertising device 100 can retrieve the advertising content C01 as a distribution candidate advertising content. The advertising device 100 can perform the logical operation on the sorted advertising contents in sorted order by using the above-described interval algorithm. The advertising device 100 determines that the advertising content C01 satisfies the logical condition, so that “o” is stored in an item “logical condition”.

Furthermore, the advertising device 100 calculates, as a score of the advertising content, a sum of the static score of the advertising content and a product of a keyword representing a feature of the advertising content and the query, in addition to the above-described logical operation. Specifically, the advertising device 100 calculates a score of each of the advertising contents that are sorted in order of the static scores. In other words, the advertising device 100 calculates, as a score, the degree of match between the query and the feature amount of the advertising content, and searches for an advertising content appropriate for distribution on the basis of the calculated score.

In the example in FIG. 1, the advertising content C01 includes “sports gym” and “muscle training” as feature amounts that match words of “sports gym” and “muscle training” as behavior attributes included in the query. In this case, the advertising device 100 stores “o” in an item “feature amount” in the data table 50. Subsequently, the advertising device 100 actually calculates a score of the advertising content C01. In the example in FIG. 1, the advertising device 100 calculates, as the score, a product of a value of “sports gym” as a keyword set for the advertising content C01 and a value of “sports gym” contained in the query, that is, calculates “30×10=300”. Similarly, the advertising device 100 calculates, as the score, a product of a value of “muscle training” as a keyword set for the advertising content C01 and a value of “muscle training” contained in the query, that is, calculates “20×40=800”. Then, the advertising device 100 calculates a sum of the products and the static score, that is “300+800+90=1190”, as the score of the advertising content C01 for the user. This calculation is performed by using the above-described WAND algorithm. In this manner, the advertising device 100 derives, as search results, advertising contents in descending order of the scores. Although not illustrated in FIG. 1, the static score, the logical condition (conditional expression), and the feature amount are set for each of the advertising content C02 and the advertising content C03. The advertising device 100 sequentially performs the logical operation and the score calculation for the advertising content C02 and the advertising content C03. Then, the advertising device 100 stores processing results in the data table 50.

The advertising device 100 extracts an advertising content to be distributed to the user on the basis of the processing result of each of the advertising contents. For example, the advertising device 100 extracts, as the advertising contents to be distributed to the user, the advertising content C01 and the advertising content C03 that are retrieved from a group of distribution candidate advertising contents by using the above-described two search methods. Then, the advertising device 100 distributes the extracted advertising content C01 and the extracted advertising content C03 to the user terminal 10 (Step S14). In this case, the advertising device 100 extracts and distributes advertising contents corresponding to the number of distributions included in the query. For example, if the user terminal 10 has requested “two” advertising contents as the number of distributions, the advertising device 100 extracts and distributes “two” advertising contents.

As described above, the advertising device 100 acquires a query for extracting an advertising content, performs logical operation as to whether the acquired query satisfies a logical condition that is set in advance for each advertising content, and calculates a score indicating the degree of match between the query and the feature amount of the advertising content. Then, the advertising device 100 extracts an advertising content corresponding to the query by using results obtained by both of the logical operation and the score calculation.

Specifically, the advertising device 100 according to the embodiment can extract an advertising content that is evaluated from two different points of view such as whether the advertising content satisfies a conditional expression desired by the advertiser and whether the advertising content matches the interest of the user. Therefore, the advertising device 100 can distribute an advertising content expected to have a high appeal effect to the user. Specifically, the advertising device 100 can distribute an appropriate advertising content to a user for whom conversion (Conversion) is probably achieved or a user for whom a high click through rate (CTR) is probably achieved. Furthermore, the advertising device 100 can sequentially process distribution candidate advertising contents by using the above-described algorithm for the logical operation and the WAND algorithm for the score calculation. Therefore, it is possible to promptly extract k advertising contents, where k indicates the number of distributions. Consequently, the advertising device 100 can promptly extract an advertising content with a high appeal effect.

2. Configuration of Extraction Processing System

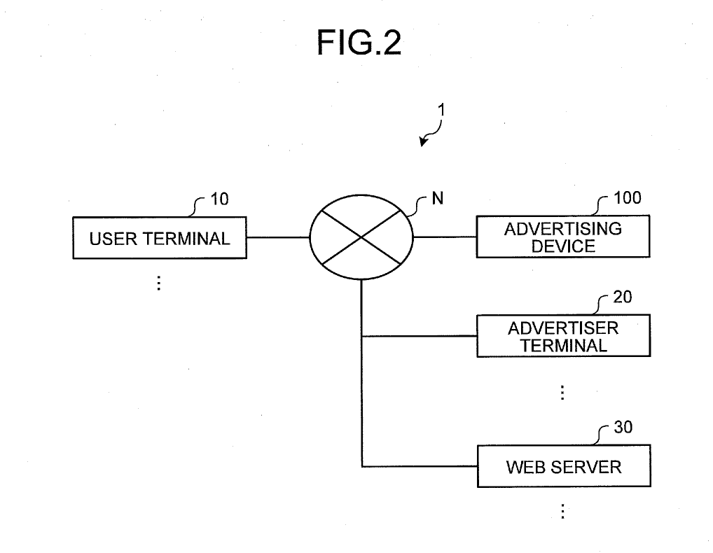

A configuration of an extraction processing system 1 including the advertising device 100 according to the embodiment will be described below with reference to FIG. FIG. 2 is a diagram illustrating a configuration example of the extraction processing system 1 according to the embodiment. As illustrated in FIG. 2, the extraction processing system 1 according to the embodiment includes the user terminal 10, an advertiser terminal 20, a web server 30, and the advertising device 100. These various devices are communicably connected to one another by wire or wireless via a network N (for example, a communication network, such as the Internet). The number of the devices included in the extraction processing system 1 is not limited to the number illustrated in FIG. 2. For example, the extraction processing system 1 illustrated in FIG. 2 may include a plurality of the user terminals 10, a plurality of the advertiser terminals 20, and a plurality of the web servers 30.

The user terminal 10 is, for example, an information processing apparatus, such as a desktop personal computer (PC), a notebook PC, a tablet terminal, a mobile phone, or a personal digital assistant (PDA). For example, the user terminal 10 accesses the web server 30 to acquire a web page provided by the web server 30, and displays the acquired web page on a display device (for example, a liquid crystal display). Then, the user terminal 10 transmits, to the advertising device 100, a query as an advertising content distribution request such that the advertising content to be displayed in an advertising space in the web page is distributed.

The advertiser terminal 20 is an information processing apparatus used by an advertiser who requests the advertising device 100 to distribute an advertisement. The advertiser terminal 20 submits an advertising content to the advertising device 100 in accordance with an operation performed by the advertiser. Furthermore, the advertiser terminal 20 sets a conditional expression for the advertising content so that the advertising content can be distributed to an appropriate distribution target.

In some cases, the advertiser may request an agent to submit the advertising content or the like, without submitting the advertising content to the advertising device 100 or setting a category of the advertising content by using the advertiser terminal 20. In this case, the agent submits the advertising content to the advertising device 100. In the following, the “advertiser” is described as a concept including not only the advertiser but also the agent, and the “advertiser terminal” is described as a concept including not only the advertiser terminal but also an agent terminal used by the agent.

The web server 30 is a server device that provides various web pages when accessed by the user terminal 10. The web server 30 provides various web pages related to, for example, a news site, a weather forecast site, a shopping site, a finance (stock price) site, a route search site, a map site, a travel site, a restaurant introduction site, or a weblog.

As described above, the web page distributed by the web server 30 includes the advertising space for displaying the advertising content. Furthermore, the web page including the advertising space includes an advertisement acquisition command for acquiring an advertising content to be displayed in the advertising space. For example, in a hypertext markup language (HTML) file or the like that forms the web page, a URL of the advertising device 100, or the like is described as the advertisement acquisition command. In this case, the user terminal 10 accesses the URL described in the HTML file or the like, and receives an advertising content distributed from the advertising device 100.

As described above, the advertising device 100 is a server device that extracts an advertising content expected to achieve a high appeal effect on the basis of the query transmitted from the user who has requested distribution of an advertisement, and distributes the extracted advertising content.

When distributing the advertising content, the advertising device 100 identifies the user terminal 10 and specifies the user terminal 10 to which the advertising content is distributed. Specifically, the user identification is possible if user identification information is included in a cookie exchanged between the web browser of the user terminal 10 and the advertising device 100. However, the user identification method is not limited to the above-described example. For example, it may be possible to set a dedicated program for the user terminal 10, and cause the dedicated program to transmit the user identification information to the advertising device 100.

3. Configuration of Advertising Device

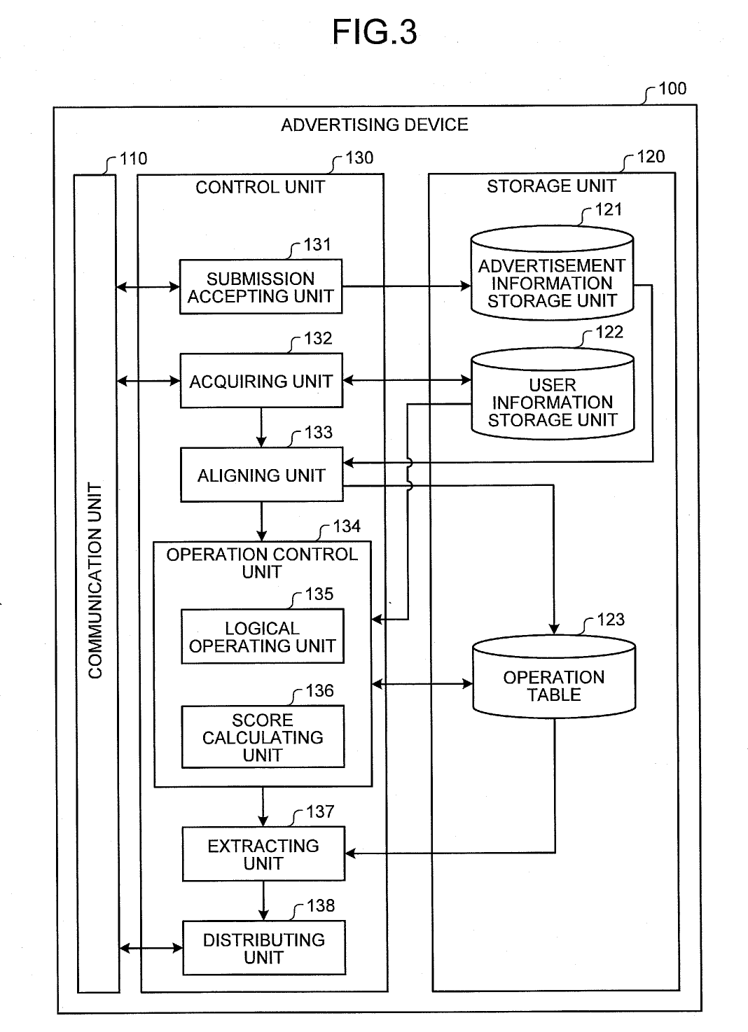

A configuration of the advertising device 100 according to the embodiment will be described below with reference to FIG. 3. FIG. 3 is a diagram illustrating a configuration example of the advertising device 100 according to the embodiment. As illustrated in FIG. 3, the advertising device 100 includes a communication unit 110, a storage unit 120, and a control unit 130. The advertising device 100 may include an input unit (for example, a keyboard, a mouse, or the like) for accepting various operations from an administrator or the like who uses the advertising device 100, or a display unit (for example, a liquid crystal display or the like) for displaying various kinds of information.

Communication Unit 110

The communication unit 110 is implemented by, for example, a network interface card (NIC) or the like. The communication unit 110 is connected to the network N by wire or wireless, and performs transmission and reception of information with the user terminal 10, the advertiser terminal 20, and the web server 30 via the network N.

Storage Unit 120

The storage unit 120 is implemented by, for example, a semiconductor memory device, such as a random access memory (RAM) or a flash memory, or a storage device, such as a hard disk or an optical disk. As illustrated in FIG. 3, the storage unit 120 includes an advertisement information storage unit 121, a user information storage unit 122, and an operation table 123.

Advertisement Information Storage Unit 12

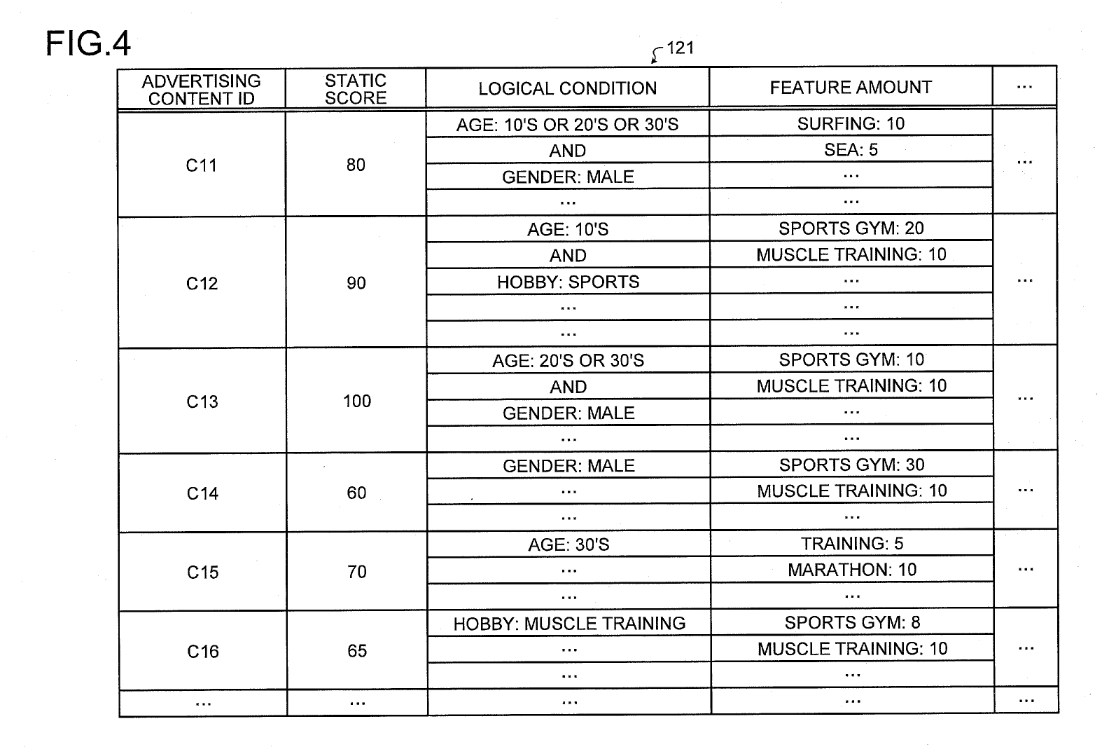

The advertisement information storage unit 121 stores therein information related to an advertising content submitted from the advertiser terminal 20. Furthermore, the advertisement information storage unit 121 stores a conditional expression set by the advertiser in association with the submitted advertising content. Moreover, the advertisement information storage unit 121 stores therein a feature amount (for example, represented by a keyword indicating the content of the advertising content) set for each advertising content. An example of the advertisement information storage unit 121 according to the embodiment is illustrated in FIG. 4. FIG. 4 is a diagram illustrating an example of the advertisement information storage unit 121 according to the embodiment. In the example illustrated in FIG. 4, the advertisement information storage unit 121 includes items of an “advertising content ID”, a “static score”, a “logical condition”, and a “feature amount”.

The “advertising content ID” is identification information for identifying an advertising content submitted from the advertiser to the advertising device 100. Data of the advertising content actually distributed to the user terminal 10 may be stored in a predetermined advertisement distribution server separated from the advertising device 100. In this case, the advertising device 100 specifies an advertising content stored in the external advertisement distribution server, on the basis of the advertising content ID stored in the advertisement information storage unit 121. Then, the advertising device 100 causes the advertisement distribution server to distribute the specified advertising content to the user terminal 10.

In the following, the identification information stored in the advertising content ID illustrated in FIG. 4 may be used as a reference symbol of the advertising content. For example, an advertising content identified by an advertising content ID “C11” may be described as an “advertising content C11”.

The “static score” indicates a value of a static score set for the advertising content. The static score is a score that is provided in advance for each advertising content, and is set based on, for example, a bid price for the advertisement or the like. The static score may be artificially set by the administrator or the like of the advertising device 100.

The “logical condition” indicates a conditional expression which uses a logical expression and which is set for each advertising content. The advertiser sets the logical condition when submitting the advertising content. Therefore, the advertiser can select a user to whom the advertising content is distributed, or can narrow down a distribution target so as to distribute the advertising content to only a user who has a specific attribute.

The “feature amount” is information indicating a feature of the advertising content by a combination of a word (keyword) and a value. The keyword related to the feature amount is a word that describes the contents of the advertising content, and, for example, is referred to when the advertising content is extracted as a distribution target. The value related to the feature amount is multiplied by, for example, the query score, and then used as an element to form a score for extracting the advertising content. Specifically, a higher value related to the feature amount represents a stronger feature of the advertising content. The feature amount is automatically set based on a to-be-advertised content or the like indicated by text or an image contained in the submitted advertising content. For example, the feature amount is obtained by performing morphological analysis on text data contained in the advertising content. The feature amount may be artificially set by the advertiser, the administrator of the advertising device 100, or the like.

Specifically, in FIG. 4, the advertising content identified by the advertising content ID “C11” is represented such that the static score is “80”, and the logical condition is set as “(age: 10's, 20's, or 30's) AND (gender: male)”, and the feature amounts are “surfing: 10” and “sea: 5”.

User Information Storage Unit 122

The user information storage unit 122 stores therein information related to a user. Specifically, the user information storage unit 122 stores therein information on a user attribute or a behavior attribute for requesting the advertising device 100 to distribute an advertising content.

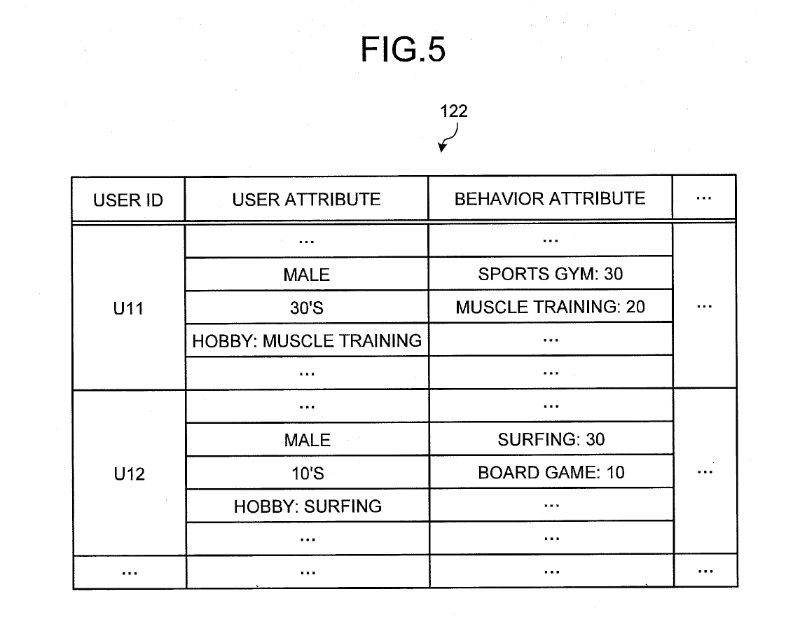

An example of the user information storage unit 122 according to the embodiment is illustrated in FIG. 5. FIG. 5 is a diagram illustrating an example of the user information storage unit 122 according to the embodiment. In the example illustrated in FIG. 5, the user information storage unit 122 includes items of a “user ID”, a “user attribute”, and a “behavior attribute”.

The “user ID” is identification information for identifying the user terminal 10 and a user who operates the user terminal 10. In FIG. 5, the user ID is represented by “U11”. This indicates that the user terminal 10 is identified by the user ID “U11” and the user terminal 10 is operated by a “user U11”.

The “user attribute” indicates information on an attribute of the user. The user attribute includes, for example, gender, age, preference, or the like of the user. The user attribute may be used as an element of the logical operation performed by the advertising device 100.

The “behavior attribute” indicates a behavior attribute of the user (that is, the user terminal 10). The behavior attribute indicates, for example, a feature of a behavior of the user based on information acquired over the network. For example, the behavior attribute is information expected to indicate an interest of the user as a result of analysis of behaviors of the user based on the cookie or the like, and is represented by, for example, a behavior content and a value (score). If the behavior attribute is used as a query, whether the behavior content included in the behavior attribute matches the feature amount included in the advertising content is determined, and a product of values of the behavior content and the feature amount is calculated as a score of the advertising content. The behavior content and the value of the behavior attribute may be artificially set, rather than being determined automatically based on the behavior history of the user. Furthermore, the behavior content and the value of the behavior attribute may be adjusted based on the characteristics of a web page including the corresponding advertising space, when distribution of the advertising content is requested. For example, when an advertising content to be displayed on a web page related to a sports gym is distributed, it may be possible to perform adjustment such that the value of the “sports gym” included in the query transmitted from the user is increased from a normal value.

Specifically, in FIG. 5, it is indicated that the user terminal 10 identified by the user ID “U11” has the user attributes of “male”, “30's”, and “hobby: muscle training”, and the behavior attributes of “sports gym: 30” and “muscle training: 20”.

Although not illustrated in FIG. 5, the user information storage unit 122 may store a device ID or the like as information for identifying the user terminal 10 itself. The device ID is identification information recorded in the terminal device itself, unlike the user ID. The user information storage unit 122 may be, for example, an externally-connected predetermined log storage server or the like, rather than being provided inside the advertising device 100. In this case, an acquiring unit 132 to be described later can acquire a log stored in the predetermined log storage server via the network N.

Operation Table 123

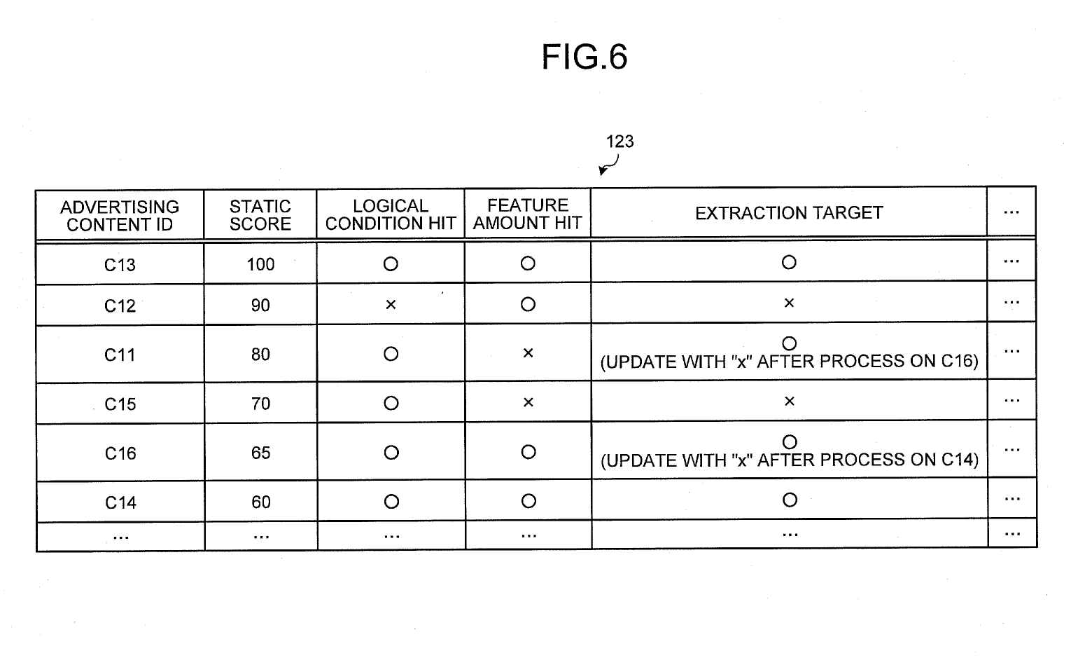

The operation table 123 is a data table used to extract an advertising content. The operation table 123 is formed by, for example, sorting (aligning) advertising contents stored in the advertisement information storage unit 121 in descending order of the static scores. The operation table 123 also stores therein results of processes performed by a logical operating unit 135 and a score calculating unit 136 to be described later. An example of the operation table 123 according to the embodiment is illustrated in FIG. 6. FIG. 6 is a diagram illustrating an example of the operation table 123 according to the embodiment. In the example illustrated in FIG. 6, the operation table 123 includes items of an “advertising content ID”, a “static score”, a “logical condition hit”, a “feature amount hit”, and an “extraction target”.

The “advertising content ID” and the “static score” correspond the same items illustrated in FIG. 4.

The “logical condition hit” indicates a result of whether the advertising content satisfies the query as a result of logical operation performed by the logical operating unit 135. For example, if the logical condition set for the advertising content satisfies the user attribute included in the query transmitted from the user, “o” is stored in the item “logical condition hit”. In contrast, if the logical condition set for the advertising content does not satisfy the user attribute included in the query transmitted from the user, “x” is stored in the item “logical condition hit”.

The “feature amount hit” indicates a result of whether to skip a calculation performed by the score calculating unit 136 at the time of the calculation performed by the score calculating unit 136. For example, if the query transmitted from the user includes a keyword indicating the feature amount representing the advertising content and if the score calculation is not skipped, “o” is stored in the item “feature amount hit”. In contrast, if the query transmitted from the user does not include a keyword indicating the feature amount representing the advertising content, or if it is obvious that a score greater than a higher score is not calculated because of use of the WAND algorithm, in other words, if the score calculation is skipped, “x” is stored in the item “feature amount hit”.

The “extraction target” indicates whether the advertising content is an extraction target. Whether the advertising content is to be an extraction target or not may be arbitrarily set by, for example, an extracting unit 137 to be described later. For example, if the extracting unit 137 sets the “logical condition hit” as a minimum extraction target, an advertising content for which the item “logical condition hit” is set to “x” is not an extraction target, and therefore, “x” is stored. As to the item “extraction target”, whether an advertising content is determined as an extraction target or not may be changed depending on the number of advertising contents to be distributed to the user terminal 10, which will be described in detail later.

Specifically, in FIG. 6, it is indicated that an advertising content identified by an advertising content ID “C13” has the static score of “100”, the logical condition hit of “o”, and the feature amount hit of “o”, and is therefore determined as the extraction target of “o” as a result of the processes.

Control Unit 130

The control unit 130 is implemented by, for example, executing various programs (corresponding to an example of an extraction program) stored in an internal storage device of the advertising device 100 by a central processing unit (CPU), a micro processing unit (MPU), or the like using a RAM as a work area. Furthermore, the control unit 130 is implemented by, for example, an integrated circuit, such as an application specific integrated circuit (ASIC) or a field programmable gate array (FPGA).

As illustrated in FIG. 3, the control unit 130 includes a submission accepting unit 131, the acquiring unit 132, an aligning unit 133, an operation control unit 134, the extracting unit 137, and a distributing unit 138, and implements or executes functions and operations of information processing as described below. The internal configuration of the control unit 130 is not limited to the configuration illustrated in FIG. 3, and any other configuration that performs the information processing as described below is applicable. Furthermore, a connection relation between the processing units of the control unit 130 is not limited to the connection relation illustrated in FIG. 3, and any other connection relation is applicable.

Submission Accepting Unit 131

The submission accepting unit 131 accepts submission of an advertising content from the advertiser terminal 20. At this time, the submission accepting unit 131 accepts a conditional expression set for each advertising content, in association with the advertising content. Then, the submission accepting unit 131 sets an advertising content ID for identifying the submitted advertising content, and stores information on the submitted advertising content in the advertisement information storage unit 121.

The submission accepting unit 131 need not always accept the conditional expression set for the advertising content simultaneously when accepting submission of the advertising content. That is, the submission accepting unit 131 may accept setting of the conditional expression after submission of the advertising content, or may accept a change in the contents of the conditional expression after accepting the setting of the conditional expression.

Acquiring Unit 132

The acquiring unit 132 acquires a distribution request for advertising content including transmission source information as information on a transmission source. Specifically, the acquiring unit 132 acquires, as the transmission source information, a query that is an advertising content distribution request including information on a user as a transmission source of the distribution request, information stored in the user terminal 10, information related to a web page in which the distributed advertising content is displayed, or the like, from the user terminal 10. More specifically, the acquiring unit 132 acquires, as the query, the number of advertising contents that the user has requested for distribution, information on an attribute of the user, information on a behavior attribute of the user, or the like.

Furthermore, the acquiring unit 132 stores the acquired transmission source information in the user information storage unit 122. That is, the acquiring unit 132 may acquire the already-stored user information from the user information storage unit 122, rather than acquiring all pieces of information needed to extract the advertising content as the query from the user terminal 10. For example, even if the transmitted query does not include information on the user attribute, the acquiring unit 132 can acquire a user attribute of the user who has transmitted the query, by specifying user information already stored in the user information storage unit 122 with reference to the user ID or the like. In this case, the acquiring unit 132 may cooperate with the web server 30 or a management device that manages the web server 30, and may sequentially acquire the information on the user terminal 10. Specifically, the acquiring unit 132 may appropriately acquire information on the cookie or the like that is exchanged when the user terminal 10 accesses the web server 30. For example, the acquiring unit 132 acquires, as the user information, information on age, gender, interest, residence, or the like of the user. When the advertising device 100 acquires an advertising content distribution request, and if a query such as the above-described transmission source is not acquired from the distribution request or if the acquired query is not adequate to perform the extraction process, the advertising device 100 may distribute an advertising content without performing the extraction process as described below. In this case, the advertising device 100 distributes an advertising content that is not targeted for a specific user but can be distributed to any user.

Aligning Unit 133

The aligning unit 133 aligns (sorts) advertising contents included in a group of advertising contents as distribution candidates, in order of predetermined evaluation values that are set in advance for the respective advertising contents. Specifically, the aligning unit 133 aligns the advertising contents in descending order of the static scores that are evaluation values set for the respective advertising contents. Then, the aligning unit 133 stores, as the operation table 123, a data table obtained by aligning the advertising contents in descending order of the static scores.

Operation Control Unit 134

The operation control unit 134 performs a predetermined operation process on an advertising content. For example, the operation control unit 134 performs a determination process of determining whether an advertising content corresponds to a distribution condition that is set in advance for each advertising content and a calculation process of calculating a score indicating the degree of match between the transmission source information and a feature amount of the advertising content, with respect to each single advertising content in a group of advertising contents as distribution candidates on the basis of the transmission source information acquired by the acquiring unit 132. As illustrated in FIG. 3, the operation control unit 134 includes the logical operating unit 135 and the score calculating unit 136.

Logical Operating Unit 135

The logical operating unit 135 performs the determination process of determining whether an advertising content corresponds to a distribution condition that is set in advance for each advertising content, with respect to a single advertising content included in a group of distribution candidate advertising contents on the basis of the transmission source information acquired by the acquiring unit 132. For example, the logical operating unit 135 performs, as the determination process, logical operation on the distribution condition that is represented by the conditional expression of the logical operation set in advance for each advertising content. Specifically, the logical operating unit 135 performs logical operation as to whether the query acquired by the acquiring unit 132 satisfies the logical condition that is set in advance for each advertising content. More specifically, the logical operating unit 135 performs logical operation as to whether the query transmitted from the user terminal 10 satisfies the conditional expression that is the logical condition set by the advertiser with respect to the advertising content.

In this case, the logical operating unit 135 can perform the determination process by using a distribution condition including an elimination condition (operation expression represented by NOT) for eliminating the advertising content from a target to be distributed to the user. As described above, the logical operating unit 135 can perform logical operation that needs a complicated process, such as “NOT” as the elimination condition, rather than specification of a simple condition, such as a category specified by the advertiser, with respect to the advertising content. Therefore, the logical operating unit 135 can appropriately extract an advertising content for a user desired by the advertiser.

Furthermore, the logical operating unit 135 performs logical operation as to whether a plurality of advertising contents as extraction target candidates aligned by the aligning unit 133 satisfy the logical condition in alignment order. Specifically, the logical operating unit 135 preferentially performs the logical operation on an advertising content with a higher static score, so that it is possible to promptly perform the process of extracting an advertising content.

The logical operating unit 135 performs the logical operation on the group of advertising contents by using a logical operation algorithm that enables logical operation as to whether the distribution condition is satisfied in predetermined alignment order. For example, the logical operating unit 135 uses a logical operation algorithm that enables logical operation on a plurality of advertising contents that are aligned in ascending order or descending order of the static scores as the predetermined alignment order. For example, the logical operating unit 135 performs logical operation by using the above-described interval algorithm. According to the interval algorithm, it is possible to perform logical operation in sorted order even for a conditional expression in which a complicated logical condition is described, so that it is possible to promptly perform the process.

Score Calculating Unit 136

The score calculating unit 136 performs the calculation process of calculating a score indicating the degree of match between the transmission source information and the feature information on the advertising content, with respect to the group of the advertising contents as the distribution candidates on the basis of the transmission source information acquired by the acquiring unit 132. For example, the score calculating unit 136 calculates a score indicating the degree of match between the query transmitted from the user terminal 10 and the feature amount, as the feature information, of the advertising content. More specifically, when a word related to the behavior attribute of the user included in the query and a keyword related to the feature amount set for the advertising content match each other, the score calculating unit 136 calculates the score by obtaining a product of a value of the behavior attribute of the user, that is, a query score, and a value of the feature amount. Furthermore, the score calculating unit 136 calculates the total score of the advertising content by obtaining a sum of the calculated product and the static score of the advertising content.

Moreover, if the logical operating unit 135 performs operation on the advertising contents aligned by the aligning unit 133, the score calculating unit 136 calculates scores in alignment order with respect to the advertising contents subjected to the logical operation performed by the logical operating unit 135 as to whether the logical condition is satisfied. That is, the score calculating unit 136 calculates the scores of the advertising contents sorted in descending order of the static scores, in parallel to the logical operation performed by the logical operating unit 135. In this process, the score calculating unit 136 uses the WAND algorithm as described above, and efficiently selects advertising contents to be targets for the calculation of the scores from among the aligned advertising contents. For example, the score calculating unit 136 determines whether a score of an advertising content to be a processing target exceeds a minimum value of scores of advertising contents reserved as extraction candidates, on the basis of an element of the feature information on the advertising content (in this example, including each word and a value that form the feature amount, a maximum value of values corresponding to each word stored in the index, or the like), and skips the score calculation when it is determined that the score does not exceed the minimum value. Specifically, in the course of a process performed with respect to each single advertising content, the score calculating unit 136 uses, as a threshold, a minimum value of scores of advertising contents that are reserved as extraction candidates when advertising contents corresponding to the number of distributions are reserved as the extraction candidates, determines whether a score of an advertising content as a next processing target exceeds the threshold, and skips a score calculation when it is determined that the score does not exceed the threshold. Therefore, the score calculating unit 136 can perform the process of extracting an advertising content without calculating detailed scores, and can contribute to a prompt extraction process.

Furthermore, the score calculating unit 136 can skip a score calculation for an advertising content that is determined as not satisfying the logical condition as a result of the logical operation performed by the logical operating unit 135. The advertising content determined as not satisfying the logical condition is expected to be eliminated from a distribution target for the user. Therefore, by performing the above-described skip process, the score calculating unit 136 can reduce processing steps and contribute to a prompt extraction process. If the above-described skip process is performed, the operation control unit 134 changes a processing target to a next advertising content.

Extracting Unit 137

The extracting unit 137 extracts an advertising content corresponding to a distribution request from the group of advertising contents on the basis of a result of the process performed by the operation control unit 134. Specifically, the extracting unit 137 extracts an advertising content corresponding to a query that is the distribution request transmitted from the user terminal 10, on the basis of the results obtained by the logical operating unit 135 and the score calculating unit 136. For example, the extracting unit 137 extracts an advertising content that is determined as satisfying the conditional expression set by the advertiser as a result of the logical operation performed by the logical operating unit 135 and that has a high total score calculated by the score calculating unit 136. In this case, the extracting unit 137 refers to the number of distributions included in the query, and extracts the same number of advertising contents as desired by the user terminal 10.

Furthermore, the extracting unit 137 reserves, as the extraction candidates (queue), the same number of advertising contents as requested by the distribution request in descending order of the scores that are calculated for the respective advertising contents by the operation control unit 134, and extracts, as the advertising content corresponding to the distribution request, an advertising content that is reserved as the extraction candidate when the process performed by the operation control unit 134 ends. In this case, the end of the process performed by the operation control unit 134 is not limited to the time when the operation control unit 134 completes the process on all of the advertising contents in the group, but may be, for example, the time when a predetermined time given for the process has elapsed or when the operation control unit 134 completes the process on a predetermined number of advertising contents set in advance.

The process of extracting an advertising content will be described in detail below by using the operation table 123 illustrated in FIG. 6. In the following, it is assumed that the user U11 illustrated in FIG. 5 transmits information, as a query, indicating that the “number of distributions” is “2”, the user attribute is “male, 30's, hobby: muscle training”, and the behavior attributes are “sports gym: 30” and “muscle training: 20” to the advertising device 100. Furthermore, to perform calculations using the WAND algorithm, the advertising device 100 stores the maximum value of each element of the feature amount of the advertising content in the index in the operation table 123. In the example described below, it is assumed that the maximum value of “sports gym” is “30” and the maximum value of “muscle training” is “20”.

First, the logical operating unit 135 performs logical operation on the advertising content C13 at the head of data in the operation table 123 in which advertising contents are sorted in descending order of the static scores. Specifically, the logical operating unit 135 determines whether the user attribute of “male, 30's, hobby: muscle training” included in the query satisfies a conditional expression of “(age: 20's or 30's) AND (gender: male)” of the advertising content C13. In this case, the query satisfies the conditional expression, so that the logical operating unit 135 stores “o” in the item “logical condition hit” in the operation table 123.

Subsequently, the score calculating unit 136 calculates a score of the advertising content C13. Specifically, the score calculating unit 136 determines whether the behavior attributes “sports gym” and “muscle training” included in the query match “sports gym” and “muscle training” that are the feature amounts of the advertising content C13. Then, the score calculating unit 136 stores “o” in the item “feature amount hit” in the operation table 123.

Then, the score calculating unit 136 calculates a product of the behavior attribute of “sports gym: 30” in the query and the feature amount of “sports gym: 10” of the advertising content C13. Furthermore, the score calculating unit 136 calculates a product of the behavior attribute of “muscle training: 20” in the query and the feature amount of “muscle training: 10” of the advertising content C13. Then, the score calculating unit 136 calculates a sum of the obtained products and the static score of “100”. Specifically, the score calculating unit 136 calculates, as a total score of the advertising content C13, “300+200+100=600”. The score calculating unit 136 stores the score of “600” as a threshold.

Subsequently, the extracting unit 137 determines whether the advertising content C13 is an extraction target candidate by using the results obtained by both of the logical operating unit 135 and the score calculating unit 136. The extracting unit 137 stores “o” in the item “extraction target” in the operation table 123 because the logical condition and the feature amount of the advertising content C13 are hit. This indicates that the extracting unit 137 employs the advertising content C13 as a candidate advertising content to be distributed to the user. Then, the advertising device 100 performs the process on the advertising content C12 that is sorted next to the advertising content C13.

The logical operating unit 135 performs logical operation on the advertising content C12. Specifically, the logical operating unit 135 determines whether the user attribute of “male, 30's, hobby: muscle training” included in the query satisfies a conditional expression of “(age: 10's) AND (hobby: sports)” of the advertising content C12. In this case, the query does not satisfy the conditional expression, so that the logical operating unit 135 stores “x” in the item “logical condition hit” in the operation table 123.

In this case, the score calculating unit 136 determines whether the query and the feature amount of the advertising content C12 match each other, and stores “o” in the item “feature amount hit”, but the score calculating unit 136 can skip a score calculation. This is because “x” is stored in the item “logical condition hit”. In this case, the extracting unit 137 stores “x” in the item “extraction target” in the operation table 123. Then, the advertising device 100 performs the process on the advertising content C11 that is sorted next to the advertising content C12.

The logical operating unit 135 performs logical operation on the advertising content C11. Specifically, the logical operating unit 135 determines whether the user attribute of “male, 30's, hobby: muscle training” included in the query satisfies a conditional expression of “(age: 10's, 20's, or 30's) AND (gender: male)” of the advertising content C11. In this case, the query satisfies the conditional expression, so that the logical operating unit 135 stores “o” in the item “logical condition hit” in the operation table 123.

Then, the score calculating unit 136 determines whether the query and the feature amount of the advertising content C11 match each other. In this case, the feature amounts of the advertising content C11 are “surfing” and “sea” and do not match the query. Therefore, the score calculating unit 136 stores “x” in the item “feature amount hit”.

If the extracting unit 137 has set the “logical condition hit” as a minimum condition for extracting the advertising content, it may be possible to store “o” in the item “extraction target” in the operation table 123 at this moment. Specifically, even if the feature amount of an advertising content is not hit, if the logical condition of the advertising content is hit, the extracting unit 137 reserves the advertising content as an extraction target (queue) without skipping the calculation process at least until the number of distributions, that is, “2”, is satisfied. At this time, the extracting unit 137 temporarily employs the total score of “0” as a threshold. This is because the score calculating unit 136 is not able to calculate the score of the advertising content C11 (the score calculating unit 136 need not perform addition to the static score if the feature amount is not matched) and the advertising content C11 is reserved as an extraction candidate. That is, if an advertising content whose total score is greater than “0” is reserved as an extraction candidate in the subsequent process, the extracting unit 137 eliminates the advertising content C11 from the extraction candidates. In other words, if there is an advertising content whose feature amount is hit in the subsequent process, the extracting unit 137 can eliminate, from the extraction candidates, the advertising content C11 which has the total score of “0” and which is reserved in the queue.

Subsequently, the advertising device 100 performs the process on the advertising content C15 that is sorted next to the advertising content C11.

The logical operating unit 135 performs logical operation on the advertising content C15. Specifically, the logical operating unit 135 determines whether the user attribute of “male, 30's, hobby: muscle training” included in the query satisfies a conditional expression of “age: 30's” of the advertising content C15. In this case, the query satisfies the conditional expression, so that the logical operating unit 135 stores “o” in the item “logical condition hit” in the operation table 123.

Then, the score calculating unit 136 determines whether the query and the feature amount of the advertising content C15 match each other. In this case, the features amounts of the advertising content C15 are “training” and “marathon” and do not match the query. Therefore, the score calculating unit 136 stores “x” in the item “feature amount hit”.

In this case, the extracting unit 137 stores “x” in the item “extraction target” even though the advertising content C15 satisfies the “logical condition hit”. This is because the following conditions are satisfied. First, at this moment, the extracting unit 137 has already reserved the two advertising contents corresponding to the number of distributions. Furthermore, the operation control unit 134 sequentially performs the process on the advertising contents sorted in descending order of the static scores. That is, it is presumed that the advertising content C15 does not exceed the score of the advertising content C11. Therefore, the extracting unit 137 determines that the advertising content C15 cannot be a target to be distributed to the user U11, and stores “x” in the item “extraction target”. Then, the advertising device 100 performs the process on the advertising content C16 that is sorted next to the advertising content C15.

The logical operating unit 135 performs logical operation on the advertising content C16. Specifically, the logical operating unit 135 determines whether the user attribute of “male, 30's, hobby: muscle training” included in the query satisfies a conditional expression of “hobby: muscle training” of the advertising content C16. In this case, the query satisfies the conditional expression, so that the logical operating unit 135 stores “o” in the item “logical condition hit” in the operation table 123.

Then, the score calculating unit 136 determines whether the query and the feature amount of the advertising content C16 match each other. In this case, the feature amounts of the advertising content C16 are “sports gym” and “muscle training” and match the query, so that the score calculating unit 136 stores “o” in the item “feature amount hit”. In this case, the score calculating unit 136 can determine that a score greater than “0”, which is the threshold of the total score at this moment, is to be calculated, and therefore performs the process of calculating the score of the advertising content C16.

The score calculating unit 136 calculates a product of the behavior attribute of “sports gym: 30” in the query and the feature amount of “sports gym: 8” of the advertising content C16. Furthermore, the score calculating unit 136 calculates a product of the behavior attribute of “muscle training: 20” in the query and the feature amount of “muscle training: 10” of the advertising content C16. Then, the score calculating unit 136 calculates a sum of the obtained products and the static score of “65”. Specifically, the score calculating unit 136 calculates, as a total score of the advertising content C16, “240+200+65=505”. Because the total score is smaller than the current score “600”, the score calculating unit 136 stores the maximum score “505” of the extraction candidate advertising contents as a new threshold.

Subsequently, the extracting unit 137 stores “o” in the item “extraction target” in the operation table 123 because the logical condition and the feature amount of the advertising content C16 are hit. Specifically, in the process after the number of distributions, that is, “2”, is satisfied, it is sufficient for the extracting unit 137 to extract, as an extraction target, only an advertising content whose logical condition and feature amount are hit. Furthermore, the extracting unit 137 eliminates the advertising content C11 from the extraction candidates at this moment, and updates the item of “extraction target” in the operation table 123 with “x”. Then, the advertising device 100 performs the process on the advertising content C14 that is sorted next to the advertising content C16.

The logical operating unit 135 performs logical operation on the advertising content C14. Specifically, the logical operating unit 135 determines whether the user attribute of “male, 30's, hobby: muscle training” included in the query satisfies a conditional expression of “gender: male” of the advertising content C14. In this case, the query satisfies the conditional expression, so that the logical operating unit 135 stores “o” in the item “logical condition hit” in the operation table 123.

Then, the score calculating unit 136 determines whether the query and the feature amount of the advertising content C14 match each other. In this case, the feature amounts of the advertising content C14 are “sports gym” and “muscle training” and match the query, so that the score calculating unit 136 stores “o” in the item “feature amount hit”.

At this time, the score calculating unit 136 determines whether a total score of the advertising content C14 is likely to exceed “505” that is the threshold of the total score at this moment. In this case, because the query and the feature amounts match each other in terms of two items, and because the maximum value of “sports gym” stored in the index is “30” and the maximum value of “muscle training” is “20”, the score calculating unit 136 determines that the total score of the advertising content C14 is likely to exceed “500”. Therefore, the score calculating unit 136 performs a process of calculating the total score of the advertising content C14.

If the score calculating unit 136 presumes that the query and the feature amount of the advertising content C14 match each other in terms of only “muscle training”, the score calculating unit 136 can skip a score calculation process by using the WAND algorithm. This is because it is obvious that the total score of the advertising content C14 does not exceed the threshold of “505” even if the score calculating unit 136 calculates the total score of the advertising content C14 because it is already known that the maximum value of “muscle training” stored in advance in the index is “20”. Specifically, even if the feature amount of the advertising content C14 is the maximum value of “muscle training: 20”, the score calculating unit 136 calculates a sum of “400”, which is a product of “muscle training: 20” as the query score and “muscle training: 20” as the feature amount of the advertising content C14, and the static score “60”, that is, calculates “460”. Namely, even if the value of “muscle training” as the feature amount of the advertising content C14 is set to any value, it is obvious that the score does not exceed the threshold “505”, so that it is possible to skip the calculation. If the calculation process is skipped, the extracting unit 137 does not reserve the advertising content as an extraction candidate.

In the example in FIG. 6, the score calculating unit 136 determines that the score is likely to exceed the threshold “505”, and therefore calculates the total score of the advertising content C14. The score calculating unit 136 calculates a product of the behavior attribute of “sports gym: 30” in the query and the feature amount of “sports gym: 30” of the advertising content C14. Furthermore, the score calculating unit 136 calculates a product of the behavior attribute of “muscle training: 20” in the query and the feature amount of “muscle training: 10” of the advertising content C14. Then, the score calculating unit 136 calculates a sum of the obtained products and the static score of “60”. Specifically, the score calculating unit 136 calculates, as the total score of the advertising content C14, “900+200+60=1160”. Because the total score exceeds the threshold of “505” at this moment, the score calculating unit 136 stores the minimum value of “600” at this moment as a new threshold.

The extracting unit 137 determines that an advertising content with a higher total score is more suitable as an advertising content to be preferentially distributed to the user U11. For example, if it is assumed that the process performed by the operation control unit 134 ends at this moment, the extracting unit 137 extracts, as the advertising contents corresponding to the query transmitted by the user U11, the advertising content C14 (total score: 1160) and the advertising content C13 (total score: 600) that are reserved as the extraction candidates. Furthermore, the extracting unit 137 eliminates the advertising content C16 from the extraction candidates at this moment, and updates the item of “extraction target” in the operation table 123 with “x”.

As described above, the advertising device 100 aligns the submitted advertising contents based on the static scores and then sequentially performs the extraction process. Therefore, the advertising device 100 can sequentially derive extraction targets with respect to each single advertising content, and therefore can skip an unnecessary process and can extract an appropriate advertising content. Consequently, the advertising device 100 can promptly extract an advertising content with a high appeal effect.

Distributing Unit 138

The distributing unit 138 distributes the advertising content extracted by the extracting unit 137 to the user terminal 10 that has transmitted the query as the advertising content distribution request acquired by the acquiring unit 132.

Data of the advertising content to be actually distributed to the user terminal 10 need not be stored in the storage unit 120 of the advertising device 100. For example, the distributing unit 138 may transmit a control command of the advertisement distribution to an externally-provided predetermined advertisement distribution server, and distributes the advertising content extracted by the extracting unit 137 to the user terminal 10.

4. Flow of Extraction Process

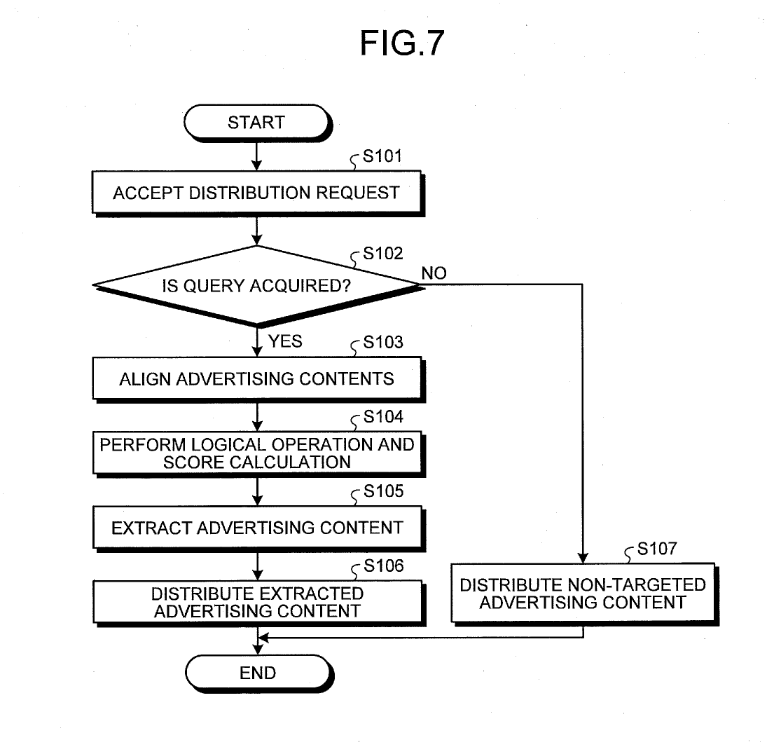

The flow of the extraction process performed by the advertising device 100 according to the embodiment will be described below with reference to FIG. 7. FIG. 7 is a flowchart illustrating the flow of the extraction process performed by the advertising device 100 according to the embodiment.

As illustrated in FIG. 7, the acquiring unit 132 accepts an advertising content distribution request from the user terminal 10 (Step S101). The acquiring unit 132 determines whether a query including transmission source information is acquired together with the distribution request (Step S102). If the query is acquired (YES at Step S102), the acquiring unit 132 sends the acquired query to the aligning unit 133, and starts a process of extracting advertising contents. The aligning unit 133 aligns the advertising contents in descending order of the static scores (Step S103).

Subsequently, the operation control unit 134 sequentially performs the logical operation and the score calculation on the aligned advertising contents (Step S104). The extracting unit 137 extracts an advertising content on the basis of a result of each of the processes performed by the operation control unit 134 (Step S105). Subsequently, the distributing unit 138 distributes the advertising content extracted by the extracting unit 137 to the user terminal 10 that has transmitted the query (Step S106).

In contrast, at Step S102, if the query (transmission source information) is not acquired (NO at Step S102), the distributing unit 138 distributes an advertising content that is not targeted to a specific user but can be distributed to any user (Step S107). The case where the query is not acquired includes not only the case where all pieces of information on the query are not acquired, but also the case where a part of the transmission source information is acquired but the process according to the embodiment is not implemented because of a lack of other information. Thus, the extraction process performed by the advertising device 100 is completed.

5. Modifications

The above-described advertising device 100 may be embodied in various different forms other than the above-described embodiment. Therefore, other embodiments of the advertising device 100 will be described below.

5-1. Batch Processing

In the above-described embodiment, an example has been described in which the advertising device 100 performs the process on the advertising contents that are sorted in advance in descending order of the static scores. However, the advertising device 100 may perform, as a batch, the logical operation on a group of submitted advertising contents, and may calculate scores based on a result of the batch processing.

Specifically, if the minimum condition for extraction is set such that a conditional expression set by an advertiser is satisfied, the advertising device 100 performs the logical operation on a group of submitted advertising contents. In this case, the advertising device 100 need not perform the logical operation on the aligned advertising contents, and therefore can perform the logical operation by using, for example, a CNF algorithm or a DNF algorithm, rather than the above-described interval algorithm. The advertising device 100 performs the score calculation process on an advertising content that satisfies the conditional expression as a result of the logical operation.

As described above, the advertising device 100 includes the acquiring unit 132 that acquires an advertising content distribution request including transmission source information as information on a transmission source; a determining unit (in this example, corresponding to the logical operating unit 135) that determines whether an advertising content corresponds to a distribution condition that is set in advance for each advertising content, with respect to a group of advertising contents as distribution candidates on the basis of the transmission source information acquired by the acquiring unit 132; the score calculating unit 136 that calculates a score indicating a degree of match between the transmission source information and a feature amount of each advertising content that is determined as an advertising content corresponding to the distribution condition by the determining unit; and the extracting unit 137 that extracts an advertising content corresponding to the distribution request by using results obtained by both of the determining unit and the score calculating unit 136.

Therefore, the advertising device 100 can use various logical operation algorithms, in addition to an algorithm such as the interval algorithm that enables the logical operation to be promptly performed on aligned processing objects. Furthermore, the advertising device 100 can perform two types of determination such as the logical operation and the score calculation with respect to a predetermined advertising content even by using the above-described method. Therefore, it is possible to distribute an advertising content with a high advertising effect to a user. In this method, it is possible to reduce a processing time by using a logical operation algorithm, such as a CNF, so that it is possible to ensure the promptness of the process even when the two types of determination are performed.

5-2. Logical Condition

In the above-described embodiment, an example has been described in which the advertising device 100 employs, as the minimum condition, extraction of an advertising content that satisfies a conditional expression set by an advertiser. However, the advertising device 100 may, not employ the extraction of the advertising content that satisfies the conditional expression as the condition for extraction. It is possible to arbitrarily determine the condition, and the advertising device 100 may employ an advertising content that does not satisfy the conditional expression as an extraction target.

Furthermore, in the above-described embodiment, an example has been described in which the advertising device 100 employs an advertising content as an extraction target when the conditional expression is completely satisfied. However, the advertising device 100 may employ, as an extraction target, an advertising content that does not completely satisfy the conditional expression. For example, when a conditional expression includes three conditions, and if an advertising content satisfies two of the conditions included in the conditional expression, the advertising device 100 may determine that the advertising content satisfies the conditional expression although the advertising content does not satisfy all of the three conditions.

Moreover, the advertising device 100 may appropriately perform a conversion process on the distribution condition accepted from an advertiser. For example, upon accepting a conditional expression of “(age: 10's, 20's, 30's, or 40's)” from the advertiser, the advertising device 100 may convert the conditional expression into a conditional expression of “NOT (age: 50's or higher)”. In this manner, if it is possible to increase the efficiency of the process as compared to the conditional expression actually set by the advertiser, or if it is possible to assume an appropriate designation as the conditional expression, the advertising device 100 can convert the conditional expression set by the advertiser. Therefore, the advertising device 100 can perform the process more promptly. Furthermore, the advertiser can distribute an advertising content based on a conditional expression optimized for a desired user without taking a time and effort to derive a complicated conditional expression.

5-3. Feature Amount

In the above-described embodiment, the advertising device 100 employs, as a condition for the feature amount hit, a condition in which the feature amount set in the advertising content and the query match each other. However, the advertising device 100 may not employ the condition in which the feature amount and the query completely match each other as the condition for the feature amount hit.

For example, assuming that “training” and “sports gym” are words that have the similarity, and if “training” and “sports gym” are included in the query and the feature amount, the advertising device 100 may store “0” in the item “feature amount hit”. Specifically, the advertising device 100 may flexibly perform operation by estimating that the feature amount is hit for words, such as synonyms, having a common concept, rather than words that completely match each other. This operation is applied in the same manner for words or the like used in the conditional expression for the logical operation.

5-4. Static Score

In the above-described embodiment, an example has been described in which the advertising device 100 sets a static score for an advertising content in advance. However, the advertising device 100 need not set the static score for the advertising content in advance. That is, the advertising device 100 can implement the process using the WAND algorithm by aligning the advertising contents in a predetermined order, rather than aligning the advertising contents in descending order of the static scores.

5-5. Condition Accepted from Advertiser

In the above-described embodiment, an example has been described in which the submission accepting unit 131 accepts an advertising content together with a conditional expression set by an advertiser. However, the submission accepting unit 131 may accept submission of an advertising content together with different information.

For example, the submission accepting unit 131 may accept, from the advertiser, designation of the desired number of distributions of advertising contents, designation of a fee for a single distribution of an advertising content, or designation of cost per acquisition (CPA). The CPA indicates a cost per the number of acquisitions of new customers when an advertising content results in conversion (acquisition of news customer). The CPA is obtained by dividing an advertisement cost by the number of conversions, and the lower value of the CPA indicates higher advertising efficiency.

6. Hardware Configuration

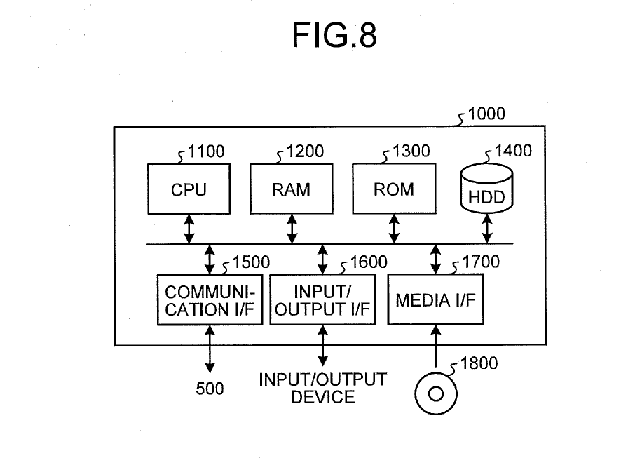

The advertising device 100 according to the above-described embodiment is implemented by, for example, a computer 1000 with a configuration as illustrated in FIG. 8. In the following, a description will be given by using the advertising device 100 as an example. FIG. 8 is a diagram illustrating an example of a hardware configuration of the computer 1000 that implements the functions of the advertising device 100. The computer 1000 includes a CPU 1100, a RAM 1200, a ROM 1300, an HDD 1400, a communication interface (I/F) 1500, an input/output I/F 1600, and a media I/F 1700.

The CPU 1100 operates based on a program stored in the ROM 1300 or the HDD 1400, and controls each of units. The ROM 1300 stores therein a boot program executed by the CPU 1100 when the computer 1000 is activated, a program that depends on the hardware of the computer 1000, and the like.

The HDD 1400 stores therein a program executed by the CPU 1100, data used by the program, and the like. The communication I/F 1500 receives data from other devices via a communication network 500 (corresponding to the network N illustrated in FIG. 2), sends the data to the CPU 1100, and transmits data generated by the CPU 1100 to other devices via the communication network 500.

The CPU 1100 controls an output device, such as a display or a printer, an input device, such as a keyboard or a mouse, and the like via the input/output I/F 1600. The CPU 1100 acquires data from the input device via the input/output I/F 1600. The CPU 1100 outputs generated data to the output device via the input/output I/F 1600.

The media I/F 1700 reads a program or data stored in a recording medium 1800, and provides the program or the data to the CPU 1100 via the RAM 1200. The CPU 1100 loads the program onto the RAM 1200 from the recording medium 1800 via the media I/F 1700, and executes the loaded program. The recording medium 1800 may be, for example, an optical recording medium such as a digital versatile disk (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the advertising device 100 according to the embodiment, the CPU 1100 of the computer 1000 implements the functions of the control unit 130 by executing the program loaded on the RAM 1200. Furthermore, the HDD 1400 stores therein data stored in the storage unit 120. While the CPU 1100 of the computer 1000 reads the program from the recording medium 1800 and executes the program, the program may be acquired from other devices as another example.

7. Others

Of the processes described in the embodiment, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in the drawings are not limited to the information illustrated in the drawings.

The components of the devices illustrated in the drawings are functionally conceptual and need not necessarily be physically configured in the manner illustrated in the drawings. In other words, specific forms of distribution and integration of the devices are not limited to those illustrated in the drawings, and all or part of the devices may be functionally or physically distributed or integrated in arbitrary units depending on various loads or use conditions. For example, the submission accepting unit 131 and the acquiring unit 132 illustrated in FIG. 3 may be integrated with each other. Furthermore, for example, the information stored in the storage unit 120 may be stored in an external storage device via the network N.

Moreover, in the above-described embodiment, an example has been described in which, for example, the advertising device 100 performs an accepting process of accepting submission of an advertising content and a query, an extraction process of extracting an advertising content to be distributed, and a distribution process of distributing the advertising content. However, the above-described advertising device 100 may be separated into an accepting device that performs the accepting process, an extraction device that performs the extraction process, and a distribution device that performs the distribution process. In this case, the accepting device includes at least the submission accepting unit 131 and the acquiring unit 132. The extraction device includes at least the aligning unit 133, the logical operating unit 135, the score calculating unit 136, and the extracting unit 137. The distribution apparatus includes at least the distributing unit 138.

Furthermore, the embodiments described above may be combined appropriately as long as the processes do not conflict with each other.

8. Advantageous Effects

As described above, the advertising device 100 according to the embodiment includes the acquiring unit 132, the operation control unit 134, and the extracting unit 137. The acquiring unit 132 acquires an advertising content distribution request including transmission source information as information on a transmission source. The operation control unit 134 performs a determination process of determining whether an advertising content corresponds to a distribution condition that is set in advance for each advertising content and a calculation process of calculating a score indicating a degree of match between the transmission source information and feature information on the advertising content, with respect to each single advertising content in a group of advertising contents as distribution candidates on the basis of the transmission source information acquired by the acquiring unit. The extracting unit 137 extracts an advertising content corresponding to the distribution request from the group of the advertising contents on the basis of results of the processes performed by the operation control unit 134.

As described above, the advertising device 100 according to the embodiment performs, for each advertising content, two processes such as the process of determining a distribution condition designated by an advertiser and the process of matching with a user indicated by the feature information or the like of the advertising content, and extracts an advertising content on the basis of results of the processes. Therefore, the advertising device 100 can extract an advertising content expected to achieve a higher advertising effect as compared to an advertising content that is extracted through a single process. Furthermore, by performing the above-described processes with respect to each single advertising content in the group of the advertising contents as the distribution candidates, the advertising device 100 can extract an advertising content without applying a processing load for searching for all of the advertising contents in the group. That is, the advertising device 100 can promptly extract an advertising content with a high appeal effect.

Furthermore, the extracting unit 137 reserves, as extraction candidates, the same number of advertising contents as requested by the distribution request in descending order of the scores that are calculated by the operation control unit 134 for the respective advertising contents, and extracts, as advertising contents corresponding to the distribution request, advertising contents reserved as the extraction candidates when the operation control unit 134 completes the processes.

As described above, in the course of the process on the advertising content included in the group of the advertising contents, the advertising device 100 according to the embodiment can perform the process while reserving advertising contents that can be employed as the extraction candidates at the moment. Therefore, for example, even if a time ensured for the extraction process is relatively short, the advertising device 100 can extract a more appropriate advertising content.

Moreover, the operation control unit 134 determines whether a score of an advertising content as a processing object exceeds a minimum value of the scores of the advertising contents that are reserved as the extraction candidates, on the basis of an element of the feature information on the advertising content, and skips a calculation of a score of the advertising content when determining that the score does not exceed the minimum value. Then, the extracting unit 137 does not reserve, as the extraction candidate, the advertising content that has been skipped by the operation control unit 134.

As described above, in the course of the process on an advertising content included in the group of advertising contents, the advertising device 100 according to the embodiment stores, as a threshold, a minimum value of scores of advertising contents that are reserved as a queue at the moment, and performs the extraction process while comparing a score with the threshold. Therefore, the advertising device 100 can skip a specific process, such as a score calculation, by only determining whether the score exceeds the threshold. Consequently, it is possible to promptly perform the extraction process.

Furthermore, the operation control unit 134 skips the calculation process for an advertising content that is determined as not satisfying a distribution condition as a result of the determination process. Then, the extracting unit 137 does not reserve, as the extraction candidate, the advertising content for which the calculation process is skipped by the operation control unit 134.

As described above, the advertising device 100 according to the embodiment can skip the score calculation for an advertising content that does not satisfy a condition designated by the advertiser. Therefore, it is possible to promptly perform the extraction process.

Moreover, the advertising device 100 according to the embodiment further includes the aligning unit 133 that aligns the advertising contents included in the group of the advertising contents in order of predetermined evaluation values that are set in advance for the respective advertising contents. The operation control unit 134 performs the determination process and the calculation process in predetermined alignment order set by the aligning unit 133. The extracting unit 137 extracts the advertising contents corresponding to the distribution request on the basis of scores of the respective advertising contents that are calculated with the predetermined evaluation values.

As described above, the advertising device 100 according to the embodiment can perform the process on the advertising contents that are sorted by using the static scores as the predetermined evaluation values that are set in advance for the respective advertising contents. Therefore, the advertising device 100 can preferentially process an advertising content expected to achieve a high effect, so that it is possible to promptly extract an advertising content with a high appeal effect.

Furthermore, the operation control unit 134 performs, as the determination process, logical operation on a distribution condition represented by a conditional expression of the logical operation that is set in advance for each of the advertising contents.

As described above, the advertising device 100 according to the embodiment accepts the distribution condition designated by the advertiser as the conditional expression for the logical operation, and performs the logical operation with respect to the conditional expression in order to extract an advertising content. Therefore, the advertising device 100 can extract an advertising content that satisfies specific designation made by the advertiser.

Moreover, the operation control unit 134 performs the logical operation on the group of the advertising contents by using a logical operation algorithm that enables logical operation as to whether the distribution condition is satisfied in predetermined alignment order.

As described above, the advertising device 100 according to the embodiment uses an algorithm that enables the logical operation on each of the aligned advertising contents, rather than on the entire group of the advertising contents. Therefore, the advertising device 100 can promptly extract an advertising content that satisfies specific designation made by the advertiser.

Furthermore, the operation control unit 134 performs the determination process by using a distribution condition including an elimination condition for eliminating an advertising content from a target to be distributed to the user.

As described above, the advertising device 100 according to the embodiment can receive designation of the distribution condition including the elimination condition (NOT operation) that needs a complicated process in the logical operation. Therefore, the advertiser can more precisely designate a user to whom the advertiser desires to perform distribution.

Moreover, the advertising device 100 according to the embodiment includes the acquiring unit 132, the logical operating unit 135 (in this example, corresponding to a determining unit that performs the determination process), the score calculating unit 136, and the extracting unit 137. The acquiring unit 132 acquires an advertising content distribution request including transmission source information as information on a transmission source. The logical operating unit 135 determines whether an advertising content corresponds to a distribution condition that is set in advance for each advertising content, with respect to a group of advertising contents as distribution candidates on the basis of the transmission source information acquired by the acquiring unit 132. The score calculating unit 136 calculates a score indicating a degree of match between the transmission source information and feature information on the advertising content with respect to an advertising content that is determined as an advertising content corresponding to the distribution condition by the logical operating unit 135. The extracting unit 137 extracts an advertising content corresponding to the distribution request by using results obtained by both of the logical operating unit 135 and the score calculating unit 136.

As described above, the advertising device 100 according to the embodiment may extract an advertising content by performing the logical operation on a group of advertising contents and calculating a score of only an advertising content that satisfies the conditional expression. In this process, the advertising device 100 can promptly perform the process by using a CNF algorithm or the like, in addition to an algorithm that enables the logical operation on each of the aligned advertising contents. Furthermore, the advertising device 100 evaluates the adequacy of the advertising content by using two types of methods such as the logical operation and the score calculation. Therefore, it is possible to extract an advertising content with a high advertising effect.

While the embodiments of the present invention have been described above in detail, these embodiments are mere examples, and the present invention may be embodied in various different forms including modifications based on the knowledge of those skilled in the art, other than the above-described embodiments.

Furthermore, “a unit” recited in the claims may be replaced with “a section, a module, or a means” or “a circuit”. For example, the acquiring unit may be replaced with an acquiring means or an acquiring circuit.

According to an embodiment of the present invention, it is possible to promptly extract an advertising content with a high appeal effect.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An extraction device comprising:
an acquiring unit that acquires a distribution request for advertising content including transmission source information as information on a transmission source of the distribution request;
an operation control unit that performs a determination process of determining whether an advertising content corresponds to a distribution condition that is set in advance for each advertising content and a calculation process of calculating a score indicating a degree of match between the transmission source information and feature information on the advertising content, with respect to each single advertising content in a group of advertising contents as distribution candidates on the basis of the transmission source information acquired by the acquiring unit; and
an extracting unit that extracts an advertising content corresponding to the distribution request from the group of the advertising contents on the basis of results of the processes performed by the operation control unit.

2. The extraction device according to claim 1, wherein the extracting unit reserves, as extraction candidates, the same number of advertising contents as requested by the distribution request in descending order of the scores that are calculated by the operation control unit for the respective advertising contents, and extracts, as advertising contents corresponding to the distribution request, advertising contents reserved as the extraction candidates when the operation control unit completes the processes.

3. The extraction device according to claim 2, wherein
the operation control unit determines whether a score of an advertising content as a processing object exceeds a minimum value of the scores of the advertising contents that are reserved as the extraction candidates, on the basis of an element of the feature information on the advertising content, and skips a calculation of a score of the advertising content when determining that the score does not exceed the minimum value, and
the extracting unit does not reserve, as the extraction candidate, the advertising content that has been skipped by the operation control unit.

4. The extraction device according to claim 2, wherein
the operation control unit skips the calculation process for an advertising content that is determined as not satisfying a distribution condition as a result of the determination process, and
the extracting unit does not reserve, as the extraction candidate, the advertising content for which the calculation process is skipped by the operation control unit.

5. The extraction device according to claim 1, further comprising:
an aligning unit that aligns the advertising contents included in the group of the advertising contents in order of predetermined evaluation values that are set in advance for the respective advertising contents, wherein
the operation control unit performs the determination process and the calculation process in predetermined alignment order set by the aligning unit, and
the extracting unit extracts the advertising contents corresponding to the distribution request on the basis of scores of the respective advertising contents that are calculated with the predetermined evaluation values.

6. The extraction device according to claim 1, wherein the operation control unit performs, as the determination process, logical operation on a distribution condition represented by a conditional expression of the logical operation that is set in advance for each of the advertising contents.

7. The extraction device according to claim 6, wherein the operation control unit performs the logical operation on the group of the advertising contents by using a logical operation algorithm that enables logical operation as to whether the distribution condition is satisfied in predetermined alignment order.

8. The extraction device according to claim 1, wherein the operation control unit performs the determination process by using a distribution condition including an elimination condition for eliminating an advertising content from a target to be distributed to the user.

9. An extraction device comprising:
an acquiring unit that acquires a distribution request for advertising content including transmission source information as information on a transmission source of the distribution request;
a determining unit that determines whether an advertising content corresponds to a distribution condition that is set in advance for each advertising content, with respect to a group of advertising contents as distribution candidates on the basis of the transmission source information acquired by the acquiring unit;
a score calculating unit that calculates a score indicating a degree of match between the transmission source information and feature information on the advertising content with respect to an advertising content that is determined as an advertising content corresponding to the distribution condition by the determining unit; and
an extracting unit that extracts an advertising content corresponding to the distribution request by using results obtained by both of the determining unit and the score calculating unit.

10. An extraction method implemented by a computer, comprising:
acquiring a distribution request for advertising content including transmission source information as information on a transmission source of the distribution request;
performing a determination process of determining whether an advertising content corresponds to a distribution condition that is set in advance for each advertising content and a calculation process of calculating a score indicating a degree of match between the transmission source information and feature information on the advertising content, with respect to each single advertising content in a group of advertising contents as distribution candidates on the basis of the transmission source information acquired at the acquiring; and
extracting an advertising content corresponding to the distribution request from the group of the advertising contents on the basis of results of the processes performed at the performing.

11. A non-transitory computer readable storage medium having stored therein an extraction program causing a computer to execute a process comprising:
acquiring a distribution request for advertising content including transmission source information as information on a transmission source of the distribution request;
performing a determination process of determining whether an advertising content corresponds to a distribution condition that is set in advance for each advertising content and a calculation process of calculating a score indicating a degree of match between the transmission source information and feature information on the advertising content, with respect to each single advertising content in a group of advertising contents as distribution candidates on the basis of the transmission source information acquired at the acquiring; and
extracting an advertising content corresponding to the distribution request from the group of the advertising contents on the basis of results of the processes performed at the performing.
